(19) United States
(12) Patent Application Publication
(10) Pub. No.: US 2022/0066804 A1
(43) Pub. Date: Mar. 3, 2022

(54) PROXY INTERPRETER TO UPGRADE AUTOMATED LEGACY SYSTEMS

(71) Applicant: Emage AI Pte Ltd, Singapore (SG)

(72) Inventors: Soon Wei Wong, Singapore (SG); Kundapura Parameshwara Srinivas, Singapore (SG)

(73) Assignee: Emage AI Pte Ltd, Singapore (SG)

(21) Appl. No.: 17/412,726

(22) Filed: Aug. 26, 2021

(30) Foreign Application Priority Data
Aug. 26, 2020 (SG) 10202008231S

(51) Int. Cl. G06F 9/455; G06N 5/02; G06N 3/04

(52) U.S. Cl. CPC G06F 9/4555; G06N 3/04; G06N 5/022

(57) ABSTRACT

The present disclosure generally relates to upgrading existing automated legacy systems. More specifically, the present disclosure relates to system and method for a proxy interpreter system to collect and consolidate the setup, configuration, operation and quality inspection data from a plurality of interfacing devices and controllers of legacy systems and subsequently build a Reinforcement learning module using the consolidated data to perform all the functions automatically without the intervention of a human operator. The consolidated data in the proxy interpreter module may be further analysed using Deep learning methods for data analytics and artificial intelligence to reliably and consistently classify the defect criteria of products to further enhance the quality of the inspection. The defect criteria classification enables the Proxy interpreter system to highlight potential problems and aid in preventive maintenance of the legacy automated systems. The Proxy interpreter system enables legacy systems to adapt and scale to manufacture newer products with no human intervention whether it is related to operation of the legacy equipment or in the process of quality control.

### BACKGROUND OF THE INVENTION

In the area of Automated Manufacturing, it becomes very important to be able to adapt computing and information processing capabilities to a more competitive, technologically advanced, and error free environment. But because legacy systems are critical components in any production automated lines, much effort and expense must be undertaken in attempting to either completely rewrite the legacy systems software or to move or migrate the system functionality into a more efficient, functional and cost-effective production environment. Rewriting a legacy system from scratch is usually not a viable option, because of the inherent liabilities of the system, the risk of failures, data loss, and no understanding of how the system architecture of legacy system is designed and how it actually performs internally, as all support ceases from the Original Equipment Manufacturer (OEM).

Automated systems have been used in a variety of microelectronic manufacturing and packaging processes. For example, in a typical semiconductor manufacturing facility (Fab), the sliced wafers are often loaded onto the equipment after setup and configuring the device parameters. These processes are usually done by an operator which is prone to errors and further affected by the feet that each operator can set up and configure the device parameters for a particular lot in different ways. After processing a wafer the operator is further required to re-inspect the defective silicon chips and decide if they are really detective or should they be reclassified as non-defective. Again here the human factor is subjected to a lot of errors. Manual operation of equipment in a manufacturing facility has been gradually replaced by an automated process to alleviate costly semiconductor manufacturing problems associated with non-automated, manual operations.

Some processes of manual operations continued even after the legacy manufacturing systems reached a point where the Original Equipment manufacturers decided to cease upgrading support or forced customers to buy new models of equipment to cater for new inspection features or simply to automate a particular task or process. Manufacturers were left in a dilemma as increased capital spending to buy new models of equipment would increase their overall production costs along with strapping of their old but reliable legacy systems. Some critical manual operations involving Human operators for Setup, Configuration and verifying detects or classifying some types of new defects continued to be essential to ensure defect free products to customers. It is a well-known fact that such manual operations involving human inspectors were prone to errors during operation, inspection, classification, documentation and training, as human error and fatigue were a constant hindering factor in maintaining efficient and optimum quality.

In addition, setting up of the legacy manufacturing systems for inspecting new kinds of silicon chips or integrated circuits was highly dependent on the operator's ability, experience and the training they have been through. Selecting the correct recipe file for a particular device setup was especially important if multiple types of silicon chips belonging to the same family of products were encountered. Recipe or configuration setup files would have accumulated over the years and new human inspectors would find it difficult to choose the correct file for optimal setup of the machine. Another problem area in manual operation at any process relates to collection and classification of data. Data could be in the form of parameter setup, defect classification, data collection related to manufacturing processes . . . etc. Manufacturing operators or inspectors often manually enter data at each process step and interact with the system computer program several times for every individual wafer lot being processed. There is also the problem of inconsistency between different operators/inspectors which further leads to error prune quality checks. The issue of consistency therefore is an issue that is to be appropriately addressed.

What is clearly needed for the manufacturer is an appropriate solution or a framework for ensuring that multiple interfaces in communication with legacy systems are fully and safely integrated through a tool that will remain transparent to the manufacturer/End user and yet introduce a new art that offers a fully automated and Reinforcement learning system that enables them to continue to use their existing base of legacy machines and eliminate or minimise all human intervention whether it is related to machine setup or post-inspection quality checks to ensure high consistency in accuracy and repeatability for a high quality output. While this requirement may apply to legacy machines it can also be suitably applied to newer equipment which may still need humans to make certain critical decisions at different process steps.

### SUMMARY OF THE INVENTION

The present invention which will henceforth be referred to as a “Proxy Interpreter” provides a system and method of automating a manufacturing process by configuring a hardware proxy interpreter unit that will build domain knowledge through Reinforcement learning to operate a piece of legacy equipment by monitoring every single activity of the human inspector on the mouse/keyboard and a set of Input/output ports. The Domain knowledge resident within the proxy interpreter will be utilised to control the legacy equipment and eventually eliminate the need for a human inspector. In one embodiment of the invention, a system and method for implementing a proxy interpreter to manage and control at least one legacy system is provided. The system and method includes steps for (a) Capturing the image of the display monitor that is being viewed and inspected by the setup and quality control operator; (b) Collecting keyboard and mouse positional coordinates with respect to the captured image during the process of setup and configuration; (c) Logging and storing the mouse, certain Input/Output ports and keyboard commands triggered by the operator and analysing the activity started by the relevant command; (d) analyzing and monitoring the subsequent results displayed on the monitor and all Input/Output ports activated by the command; (e) mapping the responses by the legacy system to build a response library based on the activated commands; and (f) using the response library to analyze multiple command activity and subsequently to control the legacy equipment without any human intervention. Eventually, the proxy interpreter overrides legacy system's input mouse-keyboard commands with its own command sequence, effectively acting as a human controlling the legacy system. The end objective of automating the legacy system without installing any software on the legacy system itself, is thus achieved.

In another embodiment of the present invention, a system and method for creating a configuration and recipe file for multiple devices is provided within the proxy interpreter to automate the Equipment set up. The system and method includes the steps of (a) Capturing the image of the display monitor that is being viewed by the quality control operator; (b) Collecting keyboard, mouse positional coordinates and certain inputs ports, with respect to the captured image during the process of setup and configuration; (c) Logging and storing the mouse, certain Input/Output ports, keyboard commands triggered by the operator and analysing the activity started by the relevant command; (d) Creating recipe or setup files that consists of configuration parameters for a particular device; and (e) Using the recipe files to automatically setup and configure the legacy system, with no human intervention during subsequent the production process.

In another embodiment of the present invention, a system and method for implementing a Deep learning module is provided within the proxy interpreter to enhance the quality of defect inspection. The system and method includes steps for (a) Classifying the defect criteria as indicated by the human inspector; (b) Applying Deep learning techniques on the classified defects and improving the defect identification process; (c) Creating new domain knowledge based on Deep learning techniques; and (d) Using the new domain knowledge to inspect and reclassify defects where applicable, to further enhance the accuracy and repeatability of inspection; This new reclassification result is used by the proxy interpreter to change the inspection result in legacy system, by overriding mouse-keyboard inputs and replicating how a human would manually change results.

### BRIEF DESCRIPTION OF THE DRAWINGS

The present invention will be described with respect to a particular embodiment thereof, and reference will be made to the drawings in which like numbers designate like parts and in which:

FIG. 1 is a block diagram view of a typical automation System that exists today having a computer system that causes the legacy System to perform the method according to a computer program;

FIG. 2 is a block diagram view of an embodiment of the automation System having a computer system that is connected to a proxy interpreter that collects information during setup and configuration of the legacy system from devices such as mouse, certain Input/Output ports and Keyboard commands in relation to the device image displayed on the monitor according to the present invention;

FIG. 3 is a flowchart that depicts the process steps during a typical inspection and classification inspection process that is followed by a human operator as per the system in FIG. 1.

FIG. 4 is a flowchart that depicts the process steps during training or teaching, according to an embodiment of the present invention as shown FIG. 2.

FIG. 5 is a flowchart that depicts the process steps followed during Reinforcement learning module creation as per the present invention shown in FIG. 2.

FIG. 5a is a flowchart that depicts the steps for Reinforcement Learning according to an embodiment of the present invention.

FIG. 6 is a flowchart that shows the automatic operation of the proxy interpreter system during normal operation of the machine, without the intervention of a human operator.

### DETAILED DESCRIPTION

The present invention relates to a method of automating the setup, configuration and operation of a microelectronic manufacturing process. While the embodiments provided below relate to a method of automating a microelectronic manufacturing process used to manufacture Semiconductor devices, it is understood that the method of the present invention may be used to automate any micro electronic manufacturing process to manufacture, for example, flat panel devices, disk drive devices, and the like. The intent is to automate a set of processes to enable legacy equipment to be used is a way that minimizes human intervention, improves the quality of the process through the use of Deep learning techniques to improve the quality of the manufacturing process and in the process extend the useful life of the legacy equipment. The present invention relates to the method of automating the manufacturing process rather than the particular type of equipment or manufacturing process being automated.

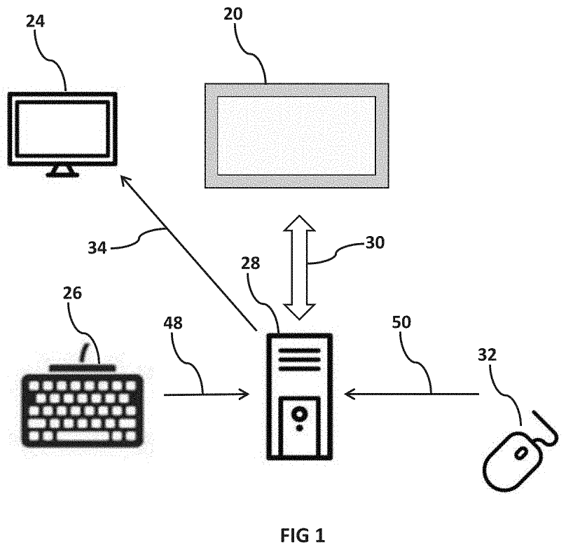

FIG. 1 is a block diagram view of a typical automation System consisting of the various components of the control system and the mechanical manufacturing system referred to as the legacy system. As such, certain devices that typically comprise the PC control system 28 are inferred in FIG. 1, such as a processor, memory (not shown), input devices comprising a mouse 32 and Keyboard 26, output devices comprising Display 24, Emergency button (Not shown), Tower indicators . . . etc that are controlled through Input/Output ports 30, some of which are connected via their relevant interfaces through USB, Ethernet port . . . etc. It is understood that more peripherals may be linked to the control system 28 to interface with the external networks or devices for implementing certain types of processes. The control system 28 interfaces with the manufacturing legacy equipment 20 to perform the steps to manufacture, inspect, sort and output the necessary data to external interfaces (not shown) for data consolidation and management.

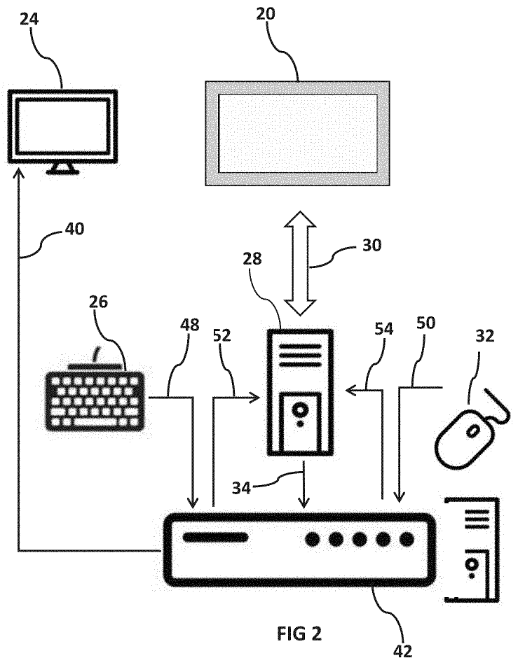

FIG. 2 is a block diagram view of an embodiment of an automation System of the present invention implemented with the Proxy server 42 that communicates with various peripherals of the legacy system to control the automated equipment 20 through the PC control system 28. In the new system architecture of the present invention, all devices that were originally connected to the PC Control system 28 are now connected to the proxy interpreter 42 which in turn communicates to the PC Control system 28 through their respective ports. In FIG. 2, input devices are connected to the proxy server 42 comprising the mouse 32 and Keyboard 26 via interface 50 and 48 respectively. The display port of the PC Control system 28 is connected to the input display port of the Proxy Server via interface 34. The proxy interpreter interfaces and communicates with PC Control system 28 to the mouse port via interface 54, the Keyboard port via interface 52, monitors and logs all activity and builds the Domain knowledge for a particular piece of automated equipment which in this case is automated equipment 20. The display monitor 24 is connected to proxy server 42 via interface 40. It is understood that more peripherals may be linked to the proxy interpreter 42 to enable it to perform additional tasks as and when required. The proxy interpreter uses the Domain knowledge built over time to control the automated equipment 20 through the PC control system 28 interface to perform the steps to control and operate the legacy machine 20.

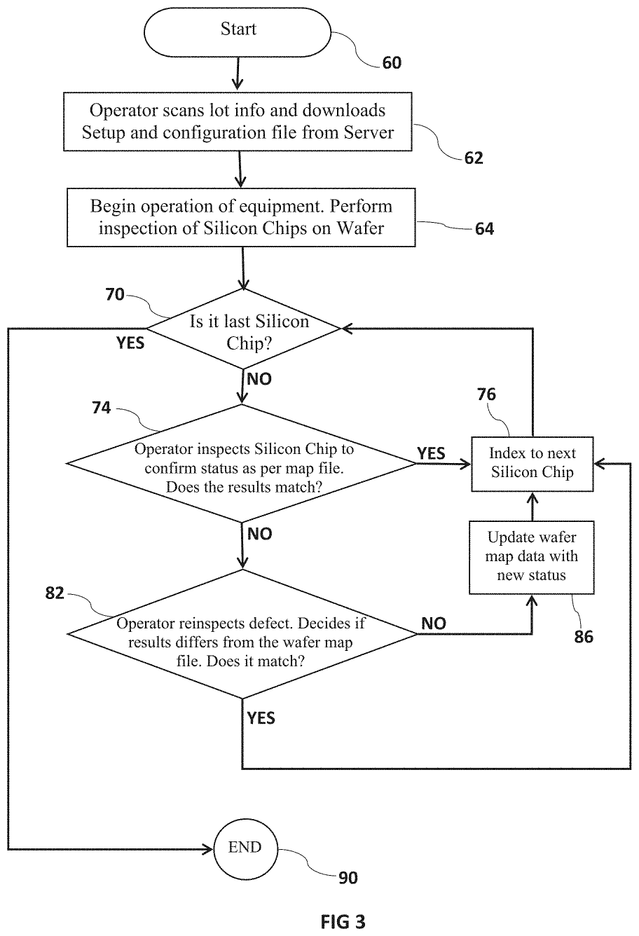

FIG. 3 is a flowchart view of a typical process flow in an automated machine. The flow chart starts with the step 60. In step 62, the operator scans the lot code from the lot document and downloads the information related to the Lot. The operator then chooses the relevant setup file from the list of configuration files based on the device to be processed. In step 64 the operation of the equipment starts and the necessary process step (in this case inspection of Silicon Chips) begins. In step 70 the computer program that controls the machine checks if the Silicon chip undergoing the inspection is the last Chip. If it is the last Silicon Chip the program moves to Step 90. If it is not the last Silicon chip, the program moves to step 74. In step 74, the operator compares the results of the inspected silicon chip with that of the results in the wafer map data file. If the results match, the program moves to next step 76. If the results does not match, the program proceeds to step 82 where the operator takes a closer look at the defect identified by the inspection program and decides if it is indeed a defect and does not match the result in the downloaded wafer map file, the operator classifies the defective silicon chip under an appropriate category and updates the information in step 86. On taking a closer look at the defect in step 82, if the operator decides that the Silicon Chip identified as defective, is not a defect, and the result matches the downloaded wafer map inspection result, the operator will decide to move to the next step 76 without updating the wafer map data file. The program then moves from Step 76 to Step 70 where the entire flow is repeated until the last Silicon Chip in the wafer.

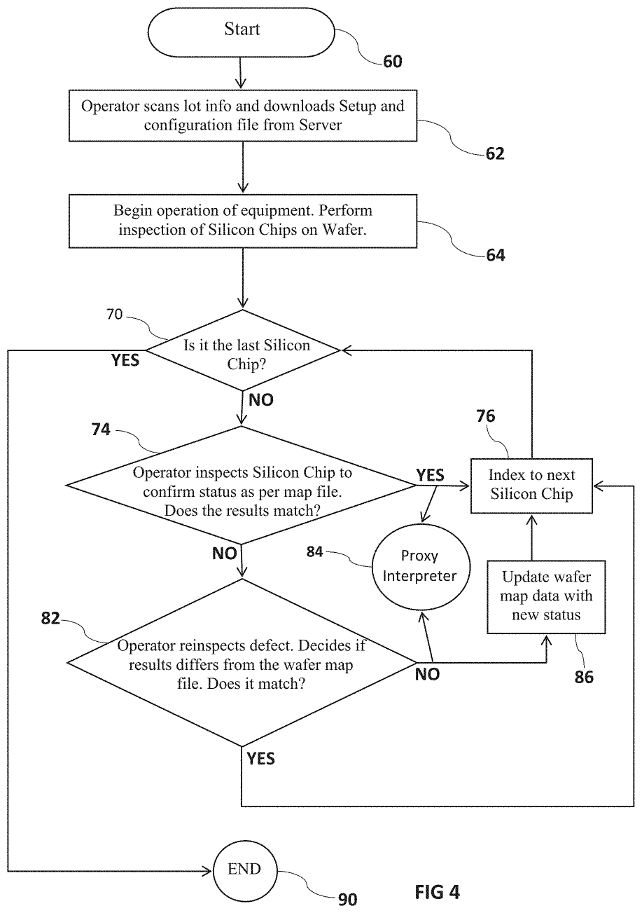

FIG. 4 is a flow chart of an embodiment of an automation system used during training or teaching, of the present invention implemented with the proxy interpreter 84 with all other process steps being the same as the flow chart in FIG. 3. The proxy interpreter monitors all activity from the Mouse 32 (FIG. 2), Keyboard 26 (FIG. 2) with respect to the image displayed on the Monitor 24 (FIG. 2) and learns the operation of the equipment 20 using a Reinforcement learning module. All data related to controls and commands encountered at the output of step 74 and 82 is consolidated and stored in the proxy interpreter. The consolidated data is analyzed to aid in building the Reinforcement learning module to be subsequently used for automatically controlling the equipment 20 without the involvement of a human operator.

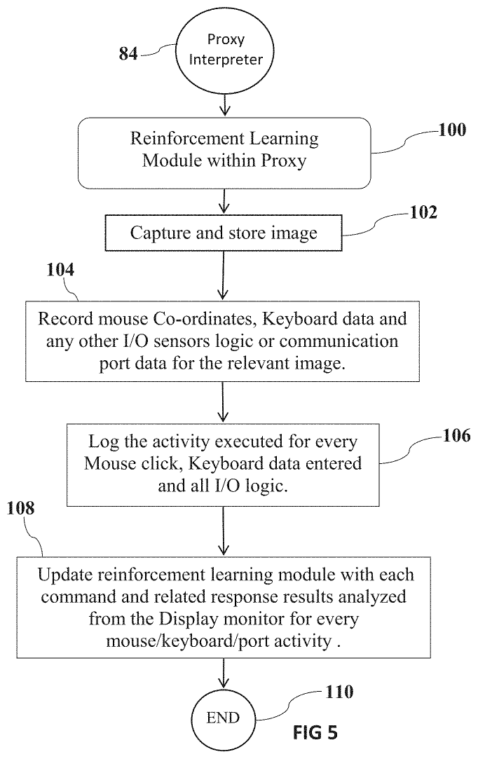

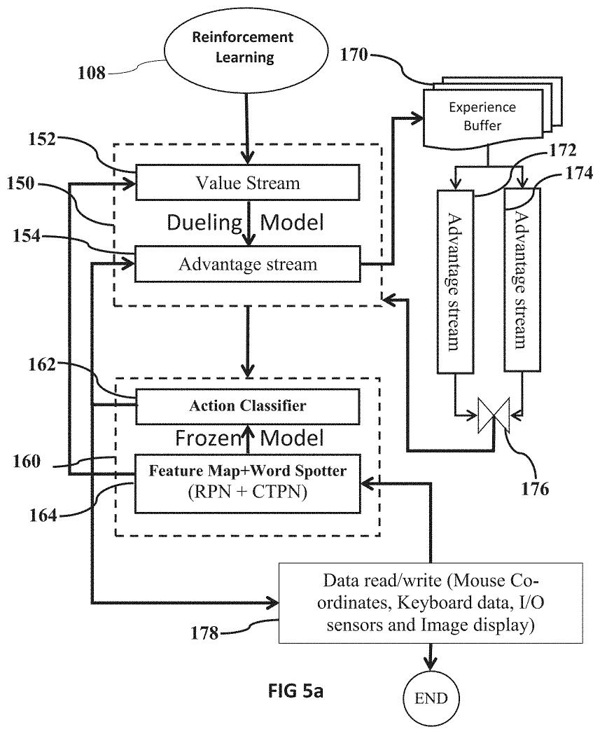

FIG. 5 is a flow chart showing the steps followed during the process of creating a Reinforcement learning module which primarily learns and stores the operating sequence of the legacy equipment. The proxy interpreter 84 shown in FIG. 4 is the starting step of the flow chart in FIG. 5. Step 100 is the entry point to the Reinforcement learning resident in the proxy interpreter. Preferably the first step maybe to capture the image on the display monitor as in Step 102. All information and data collected from the external interface devices such as Mouse, certain input/output ports and Keyboard inputs or commands, are with respect to the current image that is captured and stored in the proxy interpreter. The Reinforcement learning module stores and consolidates the inputs and outputs collected as part of the process triggered by the operator when setting up and configuring the machine in Step 104. The recording and logging of operating activity along with the intervention of operator to trigger any specific process including but not specific to verification of the device under inspection, preferably continues for every single silicon chip on the wafer as shown in step 106. In step 108, the Reinforcement learning module creates an operating flow for the various commands related to a process in the operating sequence of the legacy equipment. These commands and their related processes are used by the proxy interpreter to operate the legacy equipment with no human intervention. Step 110 represents the end of the proxy interpreter Reinforcement learning module process flow chart. The proxy interpreter may further analyze operator inputs with regards to quality control and classification of defects, to create an automatic defect classification (ADC) method using Deep learning techniques to enable legacy equipment to perform quality inspection at higher accuracy and reliability. The Deep learning module will reside in the proxy interpreter along with the Reinforcement learning module which will together aid in performance of the legacy equipment both in terms of features and productivity. The proxy interpreter helps to increase the useful life of legacy equipment which is the primary feature of the present invention.

In FIG. 5a the steps related to the Reinforcement learning module 108 in FIG. 5 is shown in more detail. The Reinforcement learning module in step 150 is implemented using “Dueling Double Deep Q Network” (D3QN) architecture which comprises of two networks: a MAIN network to learn from interacting with the environment using rewards for positive behavior and penalty for negative behavior to determine the correct actions in an interactive environment and a TARGET network (which is a frozen version of the MAIN in k training steps) to stabilize the dynamic target. The D3QN system also employs two streams: a VALUE stream 152 for learning the common Q-value (quality) of each machine state (an offset value for all the actions in that state) and an ADVANTAGE stream 154 for learning which action should be taken in a certain state. The ADVANTAGE streams in steps 172 and 174 are continuously updated by the experience buffer 170, to improve the Q value of each machine state, which is summed up at step 176 before returning to the D3QN module in step 150.

The main network gets input from feature maps 164 within the Frozen Model 160, generated by an object detection model for the display screen 178, such as a modified YOLO (You Only Look Once) and also a confidence vector for the image and text in the screen from Deep learning networks such as a modified YOLO and a modified CTPN (Connectionist Text Proposal Network) respectively. The confidence vector is used as a filter to guarantee no action is taken by the Action classifier 162 which is not relevant to the current state. Also, a custom built LSTM (Long Short Term Memory) model is used to distinguish between similar screens in different states.

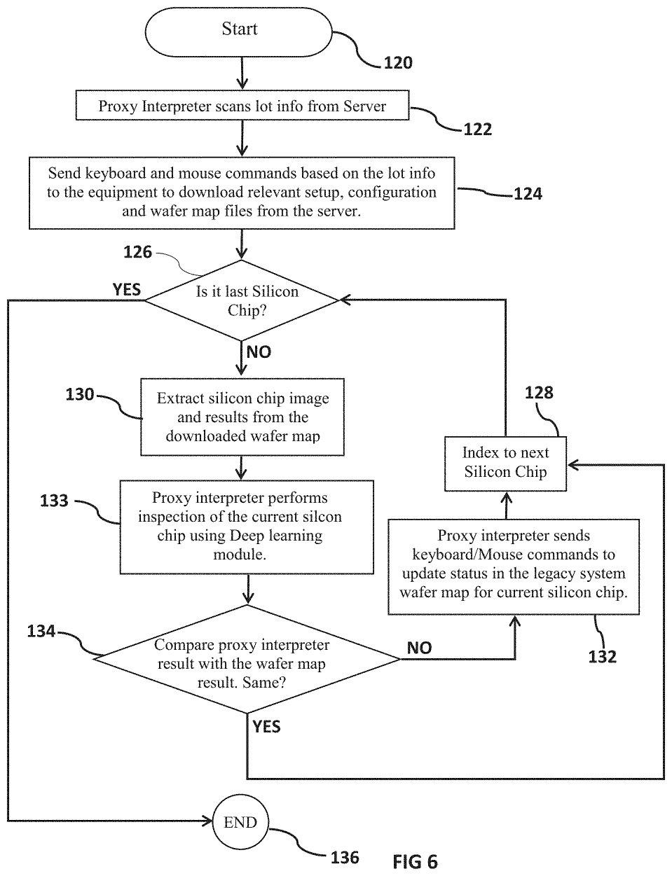

FIG. 6 is a flow chart showing the steps during normal operation of the machine, wherein the proxy interpreter system initiates all commands based on the Reinforcement and Deep learning module built during the process flow in FIG. 5. A typical proxy interpreter flow begins at Step 120 and proceeds to scan the lot information from a lot traveler or document in Step 122. The lot information is further analysed by the proxy Interpreter and the relevant keyboard and mouse commands are sent to the central server in Step 124 to download setup and configuration information into the legacy machine control system. In Step 126 the control system in the legacy machine will begin the operation of the machine by checking if the current silicon chip under the inspection camera is the last chip. If yes, the process jumps to Step 136 to end the flow of the operation in FIG. 6. If not, the operation proceeds to the next Step 130 where the defect and other information related to the current silicon ship under the camera is extracted from the wafer map file. In Step 133 the current Silicon chip under the camera is further inspected using Deep learning modules to perform highly complex analysis for enhanced inspection to arrive at a more reliable inspection result.

Deep learning modules in Step 133 are built with architectures including a modified EfficientNet and a modified Faster-RCNN (Region-based Convolutional Neural Networks), These Deep learning models are trained to identify defects on object surfaces by analysing the input image with modified ResNET-101 (Residual NETworks) layers.

Results arrived at Step 133 are compared with the results in Step 130 in Step 134. If the compared results are the same the operation proceeds to Step 128 where the machine indexes the wafer to the next Silicon chip to be inspected. If the compared results in Step 134 are not the same, in Step 132 the proxy interpreter sends relevant keyboard and mouse commands to the legacy control system, to update the current silicon chip results in the wafer map file. In effect, the results present in the wafer map file in Step 124, is overwritten with new results in Step 132 for the Silicon Chip under inspection.

The operation proceeds to Step 128 where the next Silicon chip to be inspected is indexed under the Camera. Subsequently, the operation proceeds to Step 126. The flow continues and repeats until the last Silicon chip to be inspected. This key essential feature of applying new and enhanced inspection methodology to a legacy machine through a proxy interpreter system, is the primary feature of the present invention.

The methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art by applying any neural based computational model that will fall within the spirit and scope of the principles of this disclosure. The present teaching can also be readily applied to other types of legacy systems. More particularly, multiple variations and modifications are possible in the arrangements of the subject combination arrangement within the scope of the disclosure, the drawings and the appended claims. In addition to variations and modifications in the arrangements, alternative uses will also be apparent to those skilled in the art.

1. A proxy interpreter system controlling a legacy machine using artificial intelligence connected to the PC control system, the proxy interpreter system comprising:
a server, communicatively coupled to a PC control system through multiple channels such as inputs and outputs, which operates the machine, receives and sends operating commands through hardware interfaces such as Ethernet, USB . . . etc. teaching sequences and the respective responses with reference to the image displayed on the display terminal.

2. The proxy interpreter system according to claim 1, wherein the external hardware interfaces include, the Input/Output ports, USB ports. Ethernet port, VGA port, Mouse, Keyboard and Display interface, to operate the legacy system through the PC control system, are utilised to learn & create the domain knowledge required to operate the legacy system.

3. The proxy interpreter system according to claim 2, wherein the proxy interpreter may reside as a software module within the PC control system that is controlling the legacy system and utilise its interfaces to learn and create the Domain knowledge required to operate the legacy system.

4. The proxy interpreter system according to claim 2, wherein the proxy interpreter accumulates the domain knowledge from interactions with the legacy system through commands and responses monitored through the various interfaces for all operating states of the legacy system.

5. The proxy interpreter system according to claim 4, wherein the commands and responses stored in a recipe file for a specific device type, are acquired front the keyboard commands and mouse movements made by the human operator with reference to the image on the display, combined with the relevant responses received on the Ethernet and I/O interface from the legacy system to the proxy interpreter to create the Domain knowledge for the legacy system.

6. The proxy interpreter system of claim 4, wherein the Domain knowledge created through the application of deep learning techniques and continuous reinforced learning, is subsequently utilised to operate the legacy system without the intervention of a human operator.

7. A method of training the proxy interpreter system to build an Artificial intelligence module through deep learning modules, used to select actions to be performed by interacting with the legacy system and by receiving observations of the operating sequence and stales of the system, wherein the method comprises:
obtaining a set of activities triggered from the legacy system interactive environment, with each activity comprising a process characterizing a set of events and a related command or set of commands in response to the activity;
building domain know ledge through reinforcement learning of the multiple operating states of the legacy system, using a Double Deep Q Network implementation to create a set of recipe file with various parameters for a specific device type;
processing the observations and their related actions during the legacy system setup and operation and implementing a method of of rewards and penalty for positive and negative behaviour to arrive at an optimum behavioral model to operate the legacy system effectively;
creating a confidence vector for every single action, for use as a filter to prevent a response by the action classifier for selected irrelevant operating states of the legacy system;
Constantly reviewing and updating the Advantage stream of the Reinforcement Learning module by implementing the concept of “Duelling Double Deep Q network”

8. The method of claim 6, wherein the Duelling Double Deep Q network is implemented through two streams comprising:
a VALUE stream for learning the common Q-value (quality) of each operating state of machine and an ADVANTAGE stream for learning the corresponding action for a given state of the machine.

9. The method of claim 6, wherein the ADVANTAGE stream is regularly updated through an experience buffer to aid in quality improvement and fine tuning the quality value for a given machine state.

10. The method of claim 6, wherein the Deep learning model to enhance the quality of defect inspection on object surfaces comprises:
a frozen model generated and constantly updated through using an object detection model by assigning a confidence vector to ensure no action is taken by the ACTION CLASSIFIER for any irrelevant state of the machine.
a custom built LSTM (Long short term memory) model to distinguish between similar images in different states of the machine.
a set of feature maps using a modified YOLO (You only look once) and a modified CTPN (Connectionist Text Proposal Network) for the image and text respectively.

11. The method of claim 9, wherein the reinforcement learning model implemented on the images and text information is derived from the display screen and any action taken or communicated to the legacy system is streamed through the proxy interpreter.

12. The method of claim 10, wherein the Domain knowledge created within the proxy interpreter for all operating states of the legacy system, is subsequently utilised by the proxy interpreter to automatically operate the legacy system without the intervention of a human operator.
